(19) United States
(12) Patent Application Publication
(10) Pub. No.: US 2015/0134454 A1
(43) Pub. Date: May 14, 2015

(54) Vehicle Parking Event Initiated Promotional Material System

(71) Applicant: Frogparking Limited, Palmerston North (NZ)

(72) Inventor: Donald H. Sandbrook, Palmerston North (NZ)

(73) Assignee: Frogparking Limited, Palmerston North (NZ)

(21) Appl. No.: 14/079,128

(22) Filed: Nov. 13, 2013

(51) Int. Cl. G06Q 30/02

(52) U.S. Cl. CPC G06Q 30/0261
USPC 705/14.58

(57) ABSTRACT

A vehicle parking event initiated promotional material system for providing promotional material to a mobile device initiated by a vehicle parking event. The vehicle parking event initiated promotional material system generally includes a user entering a parking identifier into an application on their mobile device, wherein the parking identifier is associated with a particular parking zone, parking spot or combination of both. The parking identifier is communicated to a server that determines if there are any promotional materials (e.g. advertisements) available for the parking identifier. If one or more promotional materials are identified by the server, the server then compares the promotional materials to the user's preferences to determine if a promotional material is within the user's preferences. Once an acceptable promotional material is identified by the server, the server communicates the promotional material to the application on the mobile device and the promotional material is then displayed to the user on the display screen of the mobile device.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to an advertising system and more specifically it relates to a vehicle parking event initiated promotional material system for providing promotional material to a mobile device initiated by a vehicle parking event.

2. Description of the Related Art

Any discussion of the related art throughout the specification should in no way be considered as an admission that such related art is widely known or forms part of common general knowledge in the field.

It is becoming increasingly difficult for businesses to advertise to potential customers with various communication mediums to advertise upon such as radio, television, Internet search engines and websites. The advertisements may be audio, text and/or graphical depending upon the communication medium used and the type of advertisement the business desires.

The main problem with conventional advertising systems is that the advertisements often times reach the potential customer at a time when it is not convenient for them to purchase the product or service or take advantage of a special offer offered by the business. In particular, the potential customer typically has to intentionally travel to the location of the business or try to remember the business (and related special offer) for the next time they are in the area of the business. Hence, significant advertising dollars are spent by businesses every year on inefficient advertisements.

Because of the inherent problems with the related art, there is a need for a new and improved vehicle parking event initiated promotional material system for providing promotional material to a mobile device initiated by a vehicle parking event.

### BRIEF SUMMARY OF THE INVENTION

The invention generally relates to an advertising system which includes a user entering a parking identifier into an application on their mobile device, wherein the parking identifier is associated with a particular parking zone, parking spot or combination of both. The parking identifier is communicated to a server that determines if there are any promotional materials (e.g. advertisements) available for the parking identifier. If one or more promotional materials are identified by the server, the server then compares the promotional materials to the user's preferences to determine if a promotional material is within the user's preferences. Once an acceptable promotional material is identified by the server, the server communicates the promotional material to the application on the mobile device and the promotional material is then displayed to the user on the display screen of the mobile device.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of the overall communication system for the present invention.

FIG. 2 is a block diagram illustrating a parking zone and a plurality of parking spaces within the parking zone.

FIG. 3 is a flowchart illustrating the creation of a user account.

FIG. 4 is a flowchart illustrating the creation of a business account.

FIG. 5 is a flowchart illustrating the overall process of the present invention to identify promotional material and displaying promotional material on the user's mobile device.

FIG. 6 is an illustration of an initial interface with menu options for the application on the mobile device.

FIG. 7 is an illustration of the parking identifier entry interface used by the user to enter the parking identifier.

FIG. 8 is an illustration of a parking identifier confirmation page in the application.

FIG. 9 is an illustration of the parking option page in the application.

FIG. 10 is an illustration of a payment page in the application.

FIG. 11 is an illustration of a saved promotions page in the application.

FIG. 12 is an illustration of promotional material displayed on the display screen of the mobile device.

FIG. 13 is an illustration of a unique promotion code displayed on the display screen of the mobile device for the user to utilize at the corresponding business to accept an offer by the business.

FIG. 14 is an illustration of a payment confirmation page displayed on the display screen of the mobile device.

### DETAILED DESCRIPTION OF THE INVENTION

### A. Overview of Invention.

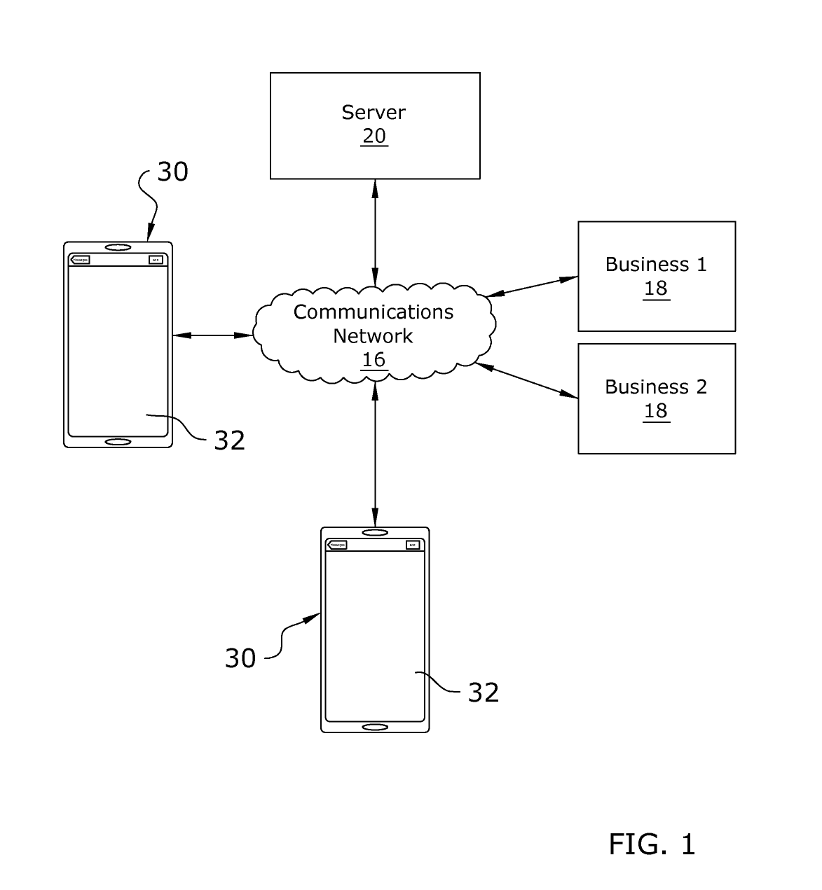

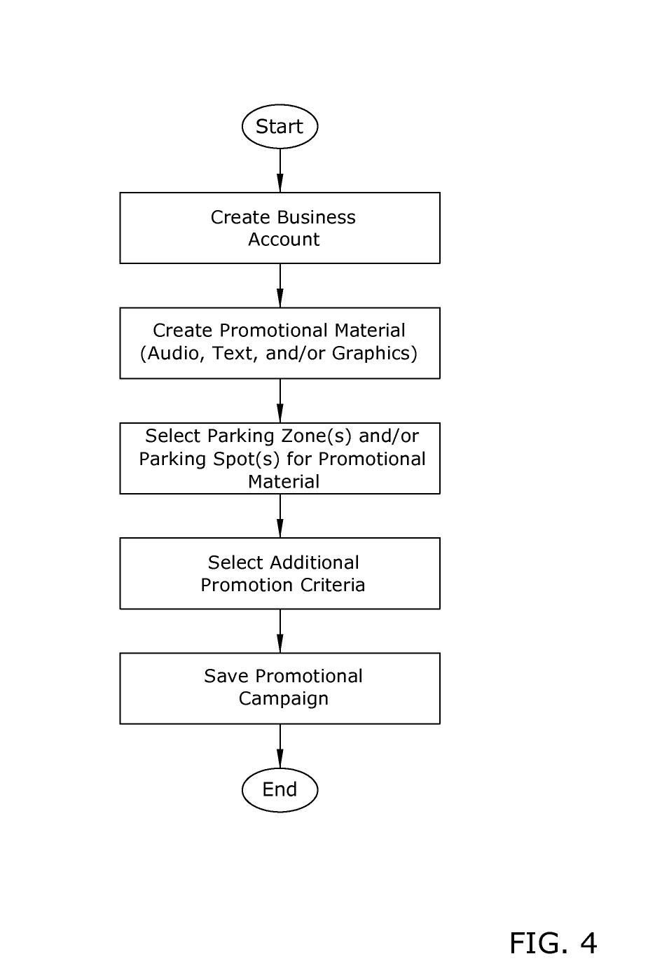

FIGS. 1 through 14 illustrate the present invention. The vehicle parking event initiated promotional material system generally includes a user entering a parking identifier into an application on their mobile device 30, wherein the parking identifier is associated with a particular parking zone 13, parking spot or combination of both. The parking identifier is communicated to a server 20 that determines if there are any promotional materials 40 (e.g. advertisements) available for the parking identifier. If one or more promotional materials 40 are identified by the server 20, the server 20 then compares the promotional materials 40 to the user's preferences to determine if a promotional material 40 is within the user's preferences. Once an acceptable promotional material 40 is identified by the server 20, the server 20 communicates the promotional material 40 to the application on the mobile device 30 and the promotional material 40 is then displayed to the user on the display screen 32 of the mobile device 30.

### B. Server.

The server 20 may be comprised of any computer, Internet-based computer, cloud based computer, virtual computer, home computer or other computer system capable of receiving and transmitting data via IP networks and the telecommunication networks. The server 20 may be comprised of any electronic system capable of receiving, storing, calculating and transmitting information (e.g. computer data, etc.). The server 20 is utilized in the present invention to receive, store and transmit business account data and user account data.

For example, individual businesses 18 can create their own individual business accounts on the server 20 through a business computer connected to the telecommunications network 16 to communicate with the server 20. A web-based interface is preferably utilized for the business to create the business account. Basic information such as the business name, business login credentials, address, contacts, e-mail address(es), website, payment information and the like may be included within the business account data. In addition, the business account data includes one or more promotional materials 40 that the business would like presented to users that are within a specific parking zone 13 and/or parking space 14.

In addition, individual users can create their own individual user accounts on the server 20 through a user's computer (e.g. mobile device, smart phone) connected to the telecommunications network 16 to communicate with the server 20. A web-based interface is preferably utilized for the user to create the user account, however, an application running on the user's computer may also be utilized to setup all of the user's preferences. Basic information such as the user's name, user's login credentials, type of vehicle 12, vehicle license plate, vehicle color, home address, work address, e-mail address(es), website, payment information, accounts of friends, social media account data, contact information for friends and the like may be included within the user account data.

In addition, the user can specify in their user account whether or not they would like to receive promotional material 40, and if they are willing to accept promotional material 40, in what manner. For example, a user may select that they do not want to receive any promotional material 40 resulting in the server 20 not providing any promotional material 40 to the user. As another example, a user may select that they prefer not to receive a specific type of promotional material 40 (e.g. promotional material 40 from men's clothing stores, advertisements without a promotional code 42 that provides a discount). The user may also select what types of promotional material 40 they prefer to receive which will receive precedence over other types of promotional material 40 (e.g. promotional material 40 for women's clothing stores, advertisements with a promotional code 42 that provides a discount of 20% or greater). As another example, the user may select that they only want to receive promotional material 40 during specified hours of the day (e.g. 5 pm-9 pm) to avoid undesirable interruptions. Also, the user may select specific parking zones 13, parking spaces 14 or other geographical areas (e.g. a city) that they want to receive promotional material 40 for.

### C. Promotional Material.

The promotional materials 40 may be comprised of an advertisement, offer, limited time offer, coupon or any other promotional item that a business can provide to a user to encourage the user to either visit the business or make a purchase of goods/services provided by the business. The promotional materials 40 may be merely a conventional type of advertisement, a special offer or a coupon.

The promotional material 40 presented to the user preferably will be for a business that is within close proximity to the parking space 14 the user parks in such as within 10 city blocks of the parking space 14. In addition, one or more promotional materials 40 may be provided to the user on the mobile device 30 simultaneously. For example, two promotional materials 40 comprised of two coupon offers by two different businesses 18 may be presented to the user simultaneously upon the display screen 32 of the mobile device 30 for the user to view and select from. Alternatively, the user may have the option of viewing only one promotional material 40 at a time and scrolling through multiple promotional materials 40 if more than one promotional material 40 is available.

The promotional materials 40 may be comprised of audio, video and/or text based promotions. The promotional materials 40 may be stored in various electronic data formats. The promotional materials 40 may also be downloaded and saved upon the mobile device 30 for later display to the user without requiring downloading of the promotional materials 40 later when the user would like to access the promotional materials 40. The promotional materials 40 may also not be stored on the mobile device 30 and instead provided to the mobile device 30 by the server 20 to be displayed to the user on the display screen 32.

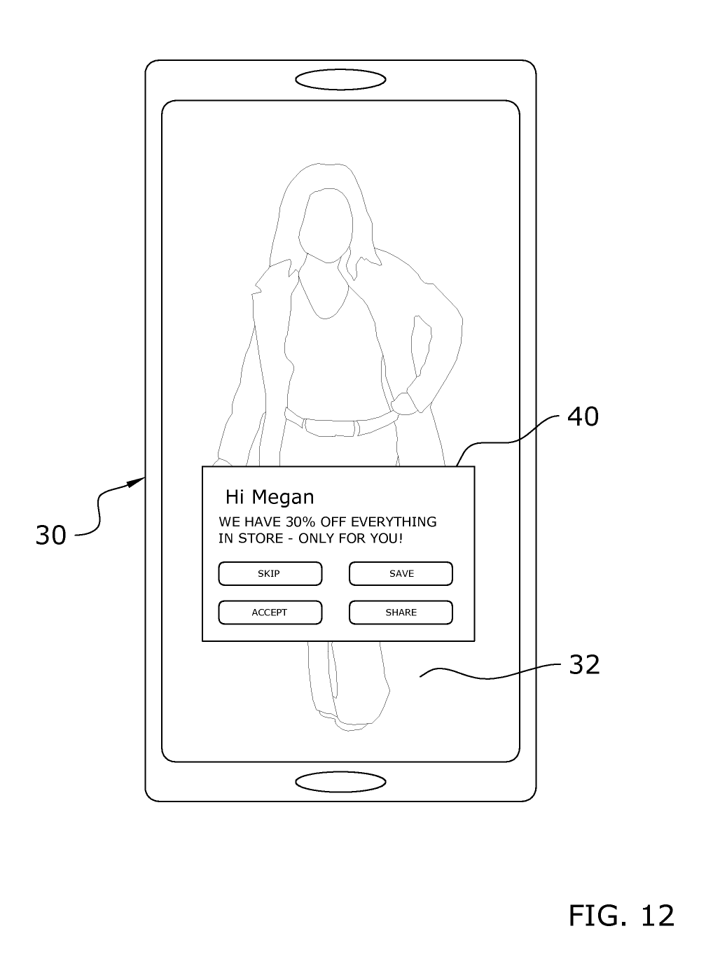

For example, the promotional materials 40 may be a human voice indicating a special offer for a business nearby. FIG. 12 illustrate exemplary promotional materials 40 that could be presented to a user. The business creates and selects how the promotional materials 40 are presented to the user on the mobile device 30. Various types of graphics (e.g. pictures, digital artwork, text) may be utilized within the promotional materials 40 to provide the message the business wants to provide to a user.

The promotional materials 40 are preferably interactive where the user can make selections such as saving for later, forwarding to a friend, sharing on a social network site (e.g. FACEBOOK) and the like. FIG. 12 illustrates an example of an interactive type of promotional material 40 where the user can select various buttons on the promotional material 40 such as “Skip” to ignore the promotional material 40, “Save Offer” to save the promotional material 40 for later viewing and access, “Share” to share the promotional material 40 on a social networking site so others can view and take advantage of the offer in the promotional material 40 (e.g. via FACEBOOK) or “Accept Offer” to accept a promotional offer such as receiving a promotion code to receive a discount at the business. The promotional materials 40 may also be comprised of a non-interactive type wherein the promotional material 40 is merely displayed for the user.

The promotional materials 40 preferably have an expiration date that the business sets (e.g. expires at 5 pm today). Alternatively, the promotional materials 40 may not have an expiration date and may be utilized by the user at any time. The promotional materials 40 may be utilized by only the user or multiple people. For example, if a promotional code 42 is provided to the user the server 20 can determine if the promotional code 42 has already been utilized before and if so deny the promotional code 42 from being utilized. Alternatively, if the promotional code 42 may be utilized by more than once, the server 20 will allow for usage of the promotional code 42 for either a period of time or until the promotional code 42 has been utilized a specified number of times (e.g. 10 uses).

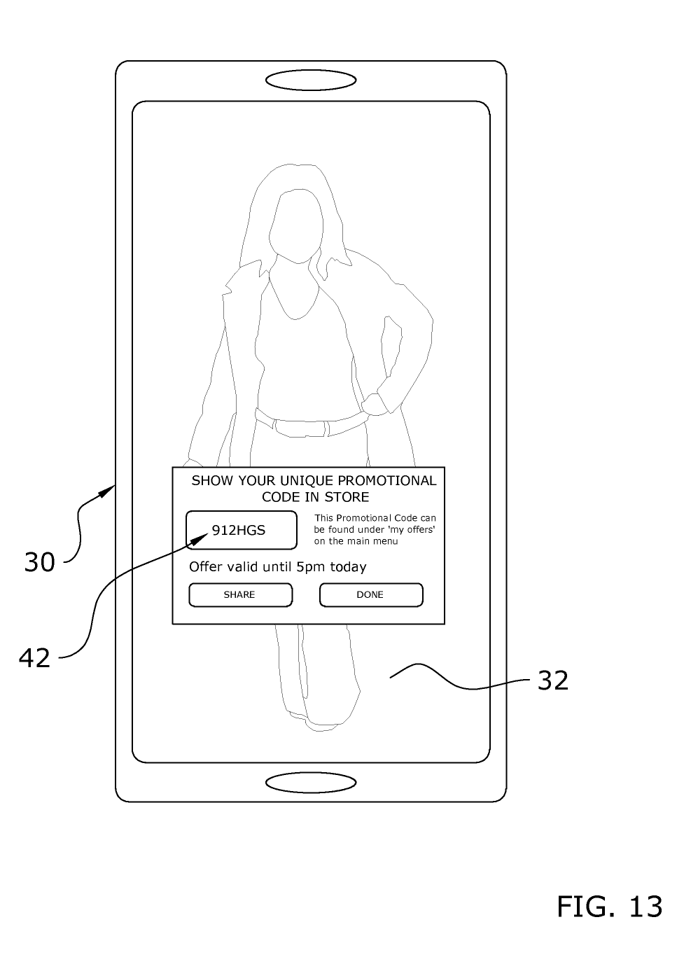

The promotional materials 40 further preferably include a promotional code 42 or other promotional identifier (e.g. bar code) that the user provides to the business to receive the benefit of the promotional material 40. An example is shown in FIGS. 12 and 13 of the drawings, wherein the promotional material 40 may include a promotional code 42 that the user presents to an employee at the business to receive 30% discount of all purchases at the store. Various other types of promotional material 40 may be utilized and displayed upon the display screen 32 of the mobile device 30.

### D. Telecommunications Network.

The present invention may be utilized upon any telecommunications network 16 capable of transmitting data including voice data and other types of electronic data. Examples of suitable telecommunications networks 16 for the present invention include but are not limited to global computer networks (e.g. Internet), wireless networks, cellular networks, satellite communications networks, cable communication networks (via a cable modem), microwave communications network, local area networks (LAN), wide area networks (WAN), campus area networks (CAN), metropolitan-area networks (MAN), and home area networks (HAN). The present invention may communicate via a single telecommunications network 16 or multiple telecommunications networks 16 concurrently. Various protocols may be utilized by the electronic devices for communications such as but not limited to HTTP, SMTP, FTP and WAP (Wireless Application Protocol). The present invention may be implemented upon various wireless networks such as but not limited to 3G, 4G, LTE, CDPD, CDMA, GSM, PDC, PHS, TDMA, FLEX, REFLEX, IDEN, TETRA, DECT, DATATAC, and MOBITEX. The present invention may also be utilized with online services and internet service providers.

The Internet is an exemplary telecommunications network 16 for the present invention. The Internet is comprised of a global computer network having a plurality of computer systems around the world that are in communication with one another. Via the Internet, the computer systems are able to transmit various types of data between one another. The communications between the computer systems may be accomplished via various methods such as but not limited to wireless, Ethernet, cable, direct connection, telephone lines, and satellite.

### E. Mobile Device.

The mobile device 30 may be comprised of any type of computer for practicing the various aspects of the present invention. For example, the mobile device 30 can be a computer (e.g. APPLE® based computer, an IBM based computer, or compatible thereof), laptop computer or tablet computer (e.g. IPAD®). The mobile device 30 may also be comprised of various other electronic devices capable of sending and receiving electronic data including but not limited to mobile electronic devices, mobile phones, smart phones telephones and personal digital assistants (PDAs).

For the present invention, it is preferable that the mobile device 30 is comprised of a portable electronic device that a user can easily bring with them in a vehicle 12. In particular, it is preferable that the mobile device 30 is comprised of a smart phone having a display screen 32 integrally within the mobile device 30. The display screen 32 may also be comprised of a touch screen for data entry and control of the application. Alternatively, a keyboard or other data entry device is in communication with the mobile device 30 for data entry by the user. The display screen 32 may be separate from the mobile device 30 such as a separate computer monitor.

### F. Software Application.

The present invention is preferably embodied in a software application stored and operated upon the mobile device 30. The application performs many of the functions and operations discussed herein in conjunction with the server 20. The application communicates with the server 20 via the telecommunications network 16 as illustrated in FIG. 1 of the drawings.

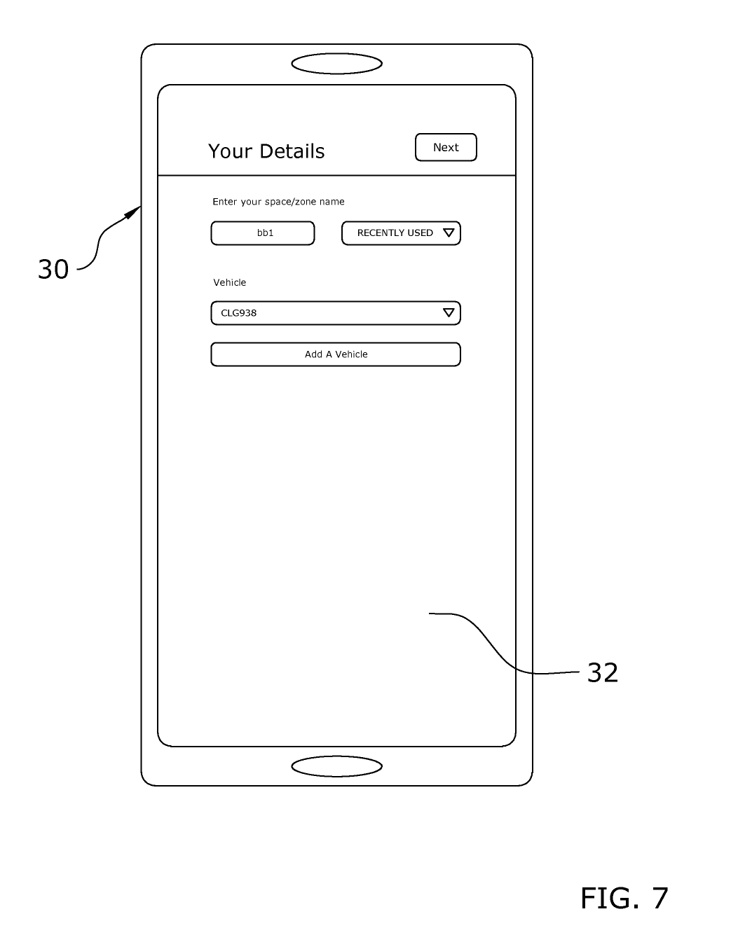

The application preferably includes a parking payment system to allow the user to identify by a parking identifier a specific parking zone 13 or specific parking space 14 that the user intends to park their vehicle 12 (e.g. car, SUV, truck, motorcycle, bicycle or other personal transportation devices) as illustrated in FIGS. 7 through 10 of the drawings. The parking payment system includes an input interface (FIG. 7) where the user is able to enter the parking identifier (parking zone 13 and/or parking space 14) along with identification of their vehicle 12. Prior used parking identifiers may be saved and accessed via a dropdown menu so the user does not have to manually enter the parking identifier each time they park their vehicle 12. The data relating to the saved data for the user may be stored directly upon the mobile device 30 and/or the server 20 for access by the user at any time.

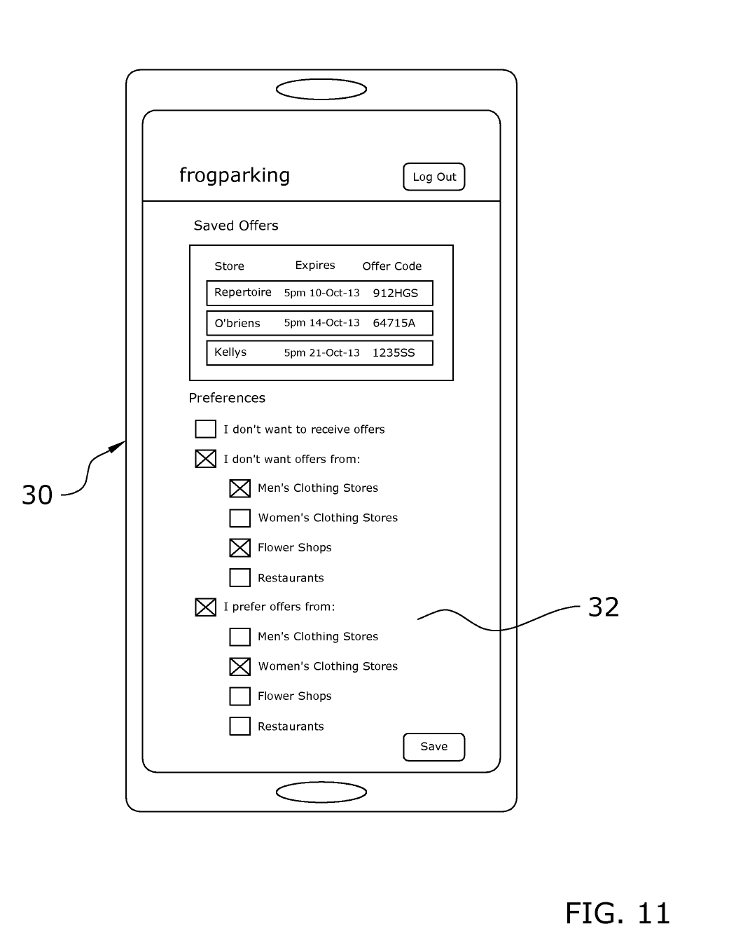

The application also is adapted to save, store, access and display prior saved promotional material 40 as illustrated in FIG. 11 of the drawings. The application displays one or more of prior saved promotional material 40 for the user to select and view at any time that is convenient for the user.

### G. Operation of Invention.

The business creates a business account utilized for managing parking spaces 14, receiving payment for renting of parking spaces 14 and/or providing promotional material 40 to users parking a vehicle 12 within a selected parking space 14 and/or parking zone 13. The business creating the business account may have an interest in the parking spaces 14 or may not have any interest in the parking spaces 14 other than advertising in relationship to them. The business creates promotional material 40 to be provided to the mobile device 30 of the user depending upon the type of user, user preferences, location of the user, the user's parking history, and/or the user's shopping history (e.g. redemption of prior promotional offers provided via the mobile device 30).

The promotional material 40 may be uploaded to the server 20 via a web interface hosted by the server 20 or provided via various other data transfer systems. The promotional material 40 is comprised of electronic data capable of being displayed on a mobile device 30 such as a mobile smart phone. The server 20 manages the display of the promotional material 40 on the users' mobile devices 30 including tracking the number of times a specific piece of promotional material 40 has been displayed, selected or ignored by users. The server 20 also manages the redemption of any promotional codes 42 and the like on behalf of the business to prevent fraud and abuse.

The business further may provide limitations and requirements on the promotional material 40 such as limiting the time of day, days of the week and holidays to display the promotional material 40. The business may also prefer to display a specific promotional material 40 for a limited period of time (e.g. 1 hour, 1 day, 1 week) after which it will no longer be displayed to users on their mobile devices 30. Furthermore, the business may limit specific to a user how long promotional material 40 is valid and redeemable for (e.g. valid and redeemable only for one-hour after being displayed). The business may also select how many times a promotional code 42 within a promotional material 40 may be redeemed (e.g. once, twice, 5 or less times, unlimited, etc.).

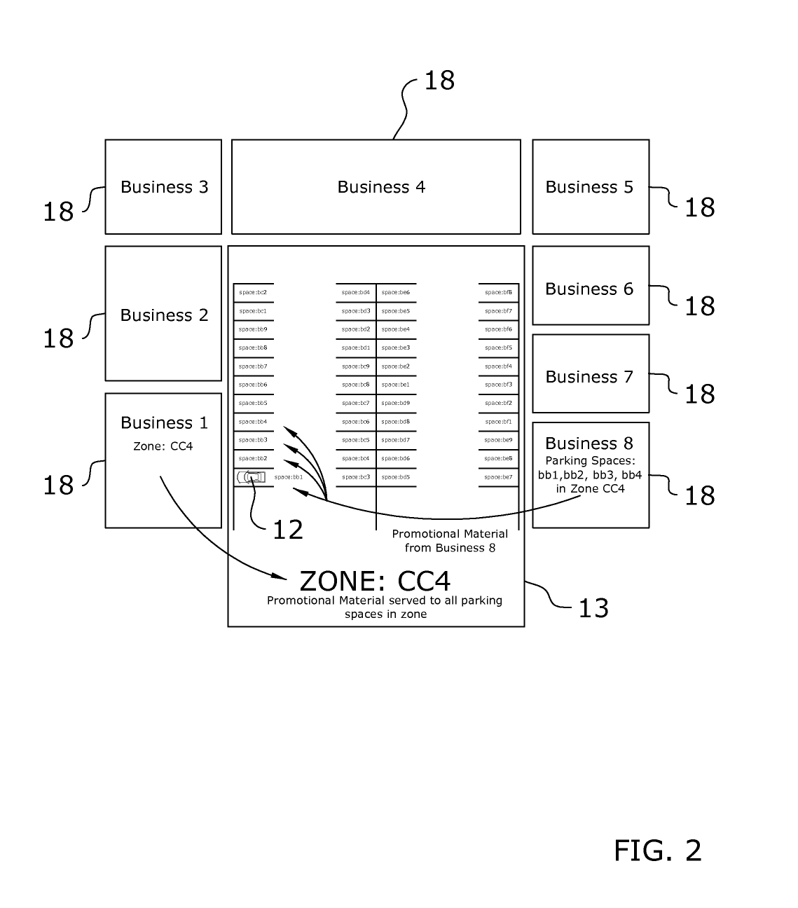

Also, the business will preferably limit the displaying of promotional material 40 to users that are parked in a parking space 14 or parking zone 13 near their business. FIG. 2 illustrates a plurality of businesses 18 (1-7) that are all adjacent to and surrounding a parking zone 13 labeled as “CC4” with a plurality of parking spaces 14 labeled “bb1, bb2, bb3 . . . bf7, bf8”. It can be appreciated that the business may selecting parking spaces 14 and/or parking zones 13 that are not adjacent to their business but it is preferable that the business select parking spaces 14 and parking zones 13 within easy walking distance of the physical location of the business (e.g. 10 or less city blocks) to provide for increased effectiveness of the promotional material 40 displayed to the users since the user's will be able to easily visit the business to purchase the related goods or services.

The parking zone 13 illustrated in FIG. 2 is basically a single parking lot. However, it can be appreciated that the parking zone 13 may be comprised of more than one parking lot depending upon the geographical location of the parking lots (i.e. two or more adjacent or nearby parking lots could be part of a single parking zone 13).

For example, FIG. 2 illustrates Business 8 providing promotional material 40 only for specifically identified parking spaces 14 (Spaces bb1, bb2, bb3 and bb4) which are directly adjacent to a competitor Business 1. Hence, only when a user parks the vehicle 12 within either spaces bb1, bb2, bb3 or bb4 will promotional material 40 from Business 8 be provided to the user. Of course other businesses 18 may be providing promotional material 40 for these same parking spaces 14 or the entire parking zone 13 which would compete with the promotional material 40 from Business 8 for promotion on the user's mobile device 30.

In addition, FIG. 2 illustrates Business 1 providing promotional material 40 for the entire parking zone 13 (Zone CC4). Hence, if a user parks the vehicle 12 in any of the parking spaces 14 in the parking zone 13 (Spaces bb1, bb2, bb3 . . . bf7, bf8), the promotional material 40 from Business 1 will be provided to the user. Of course other businesses 18 may be providing promotional material 40 for these same parking zone 13 which would compete with the promotional material 40 from Business 1 for promotion on the user's mobile device 30.

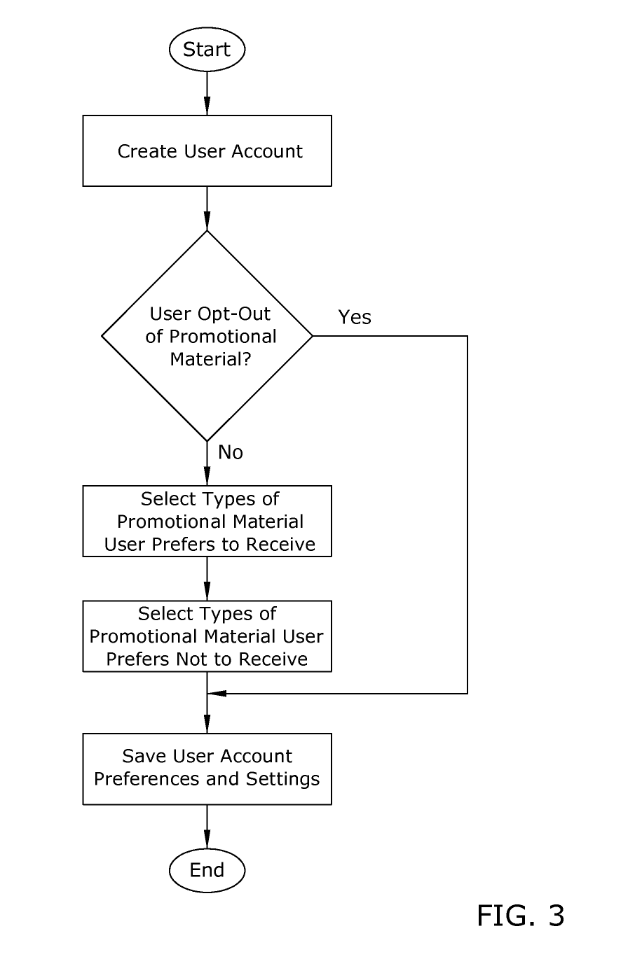

The user creates a user account utilized for paying for parking spaces 14 as illustrated in FIG. 3 of the drawings. The account may also be created on the application itself. Once the user has created a user account, the user may download and install the software application that operates the present invention onto the mobile device 30 from the server 20. The user may then log into their respective user account via the application on the mobile device 30.

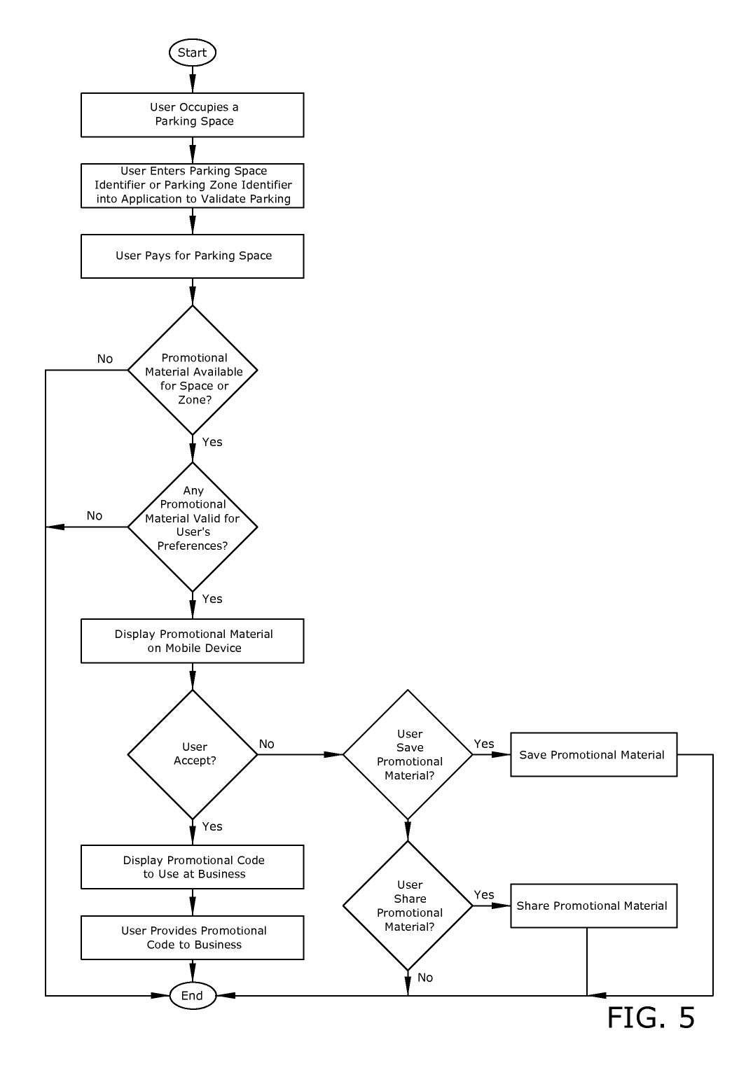

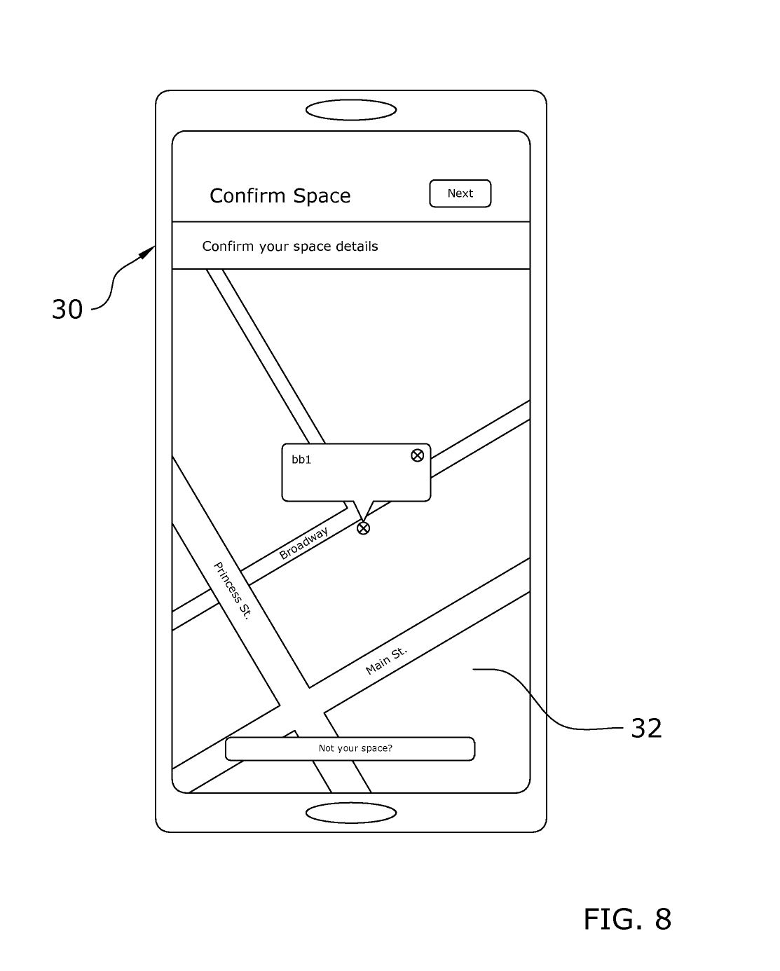

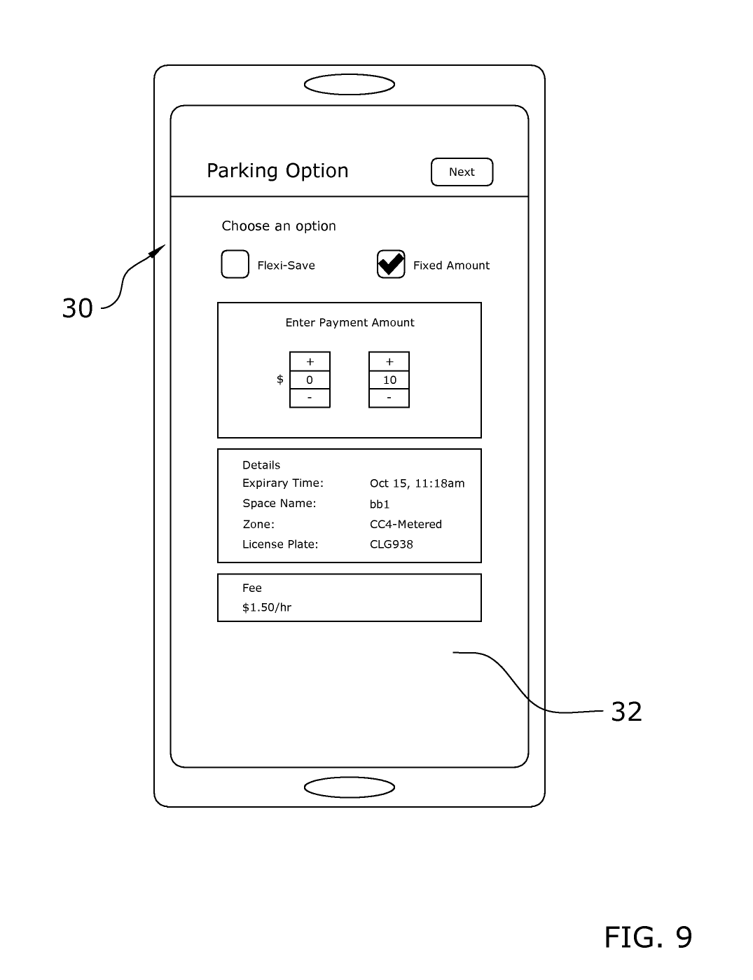

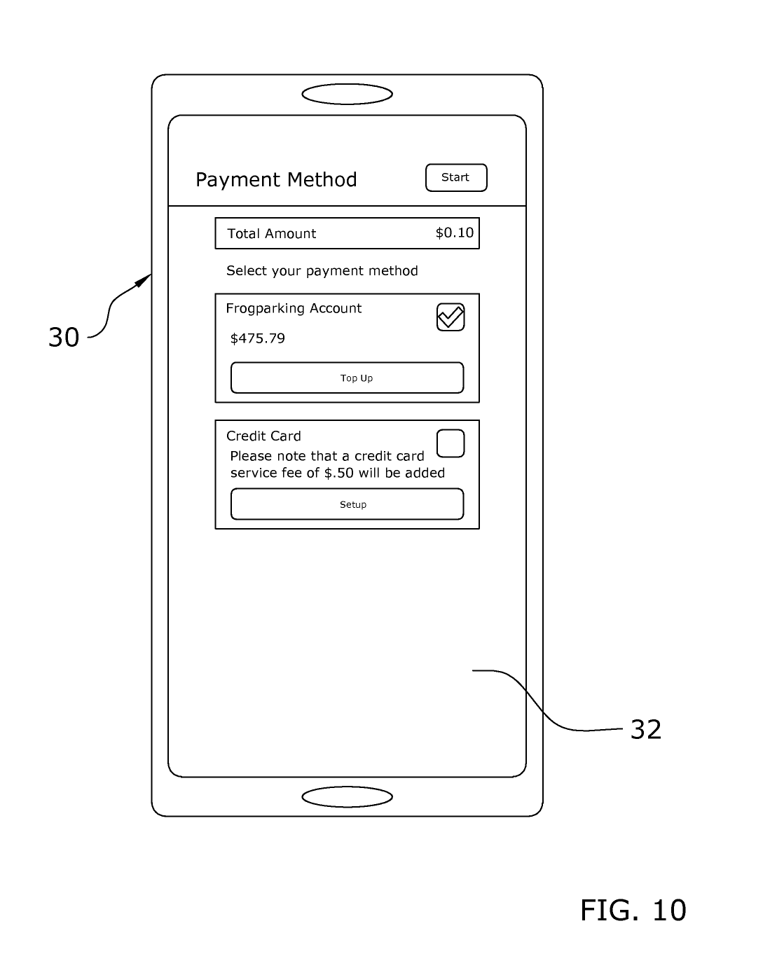

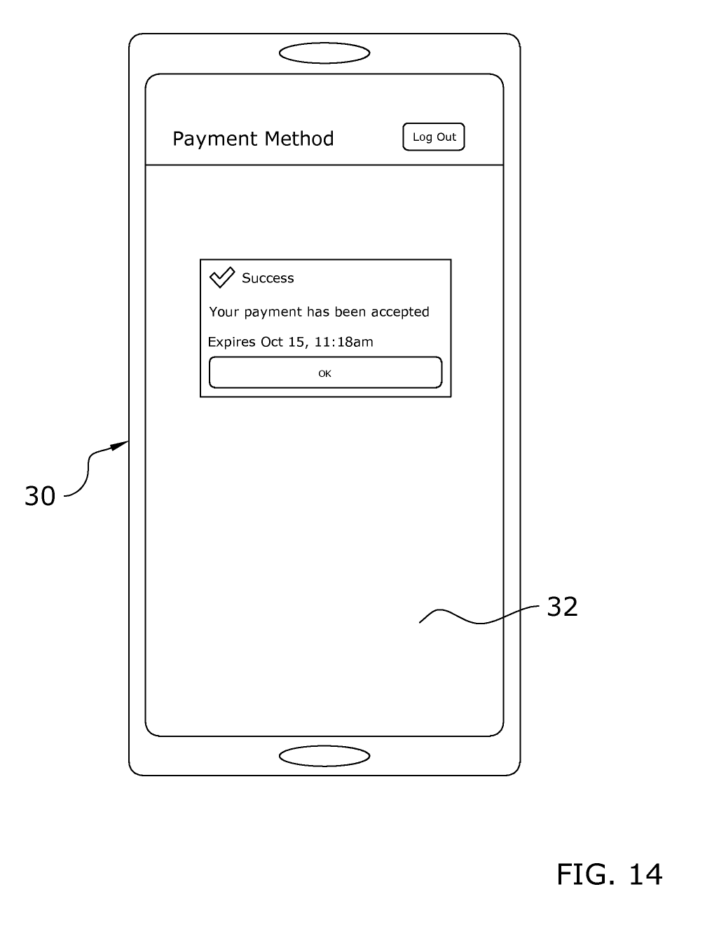

FIG. 5 illustrates an overall flowchart of the operation and functionality of a preferred embodiment of the present invention. In particular, a user operating their vehicle 12 first identifies a suitable parking space 14. As shown in FIG. 2 of the drawings, the user identifies and parks their vehicle 12 within the parking space 14 having a parking identifier of “bb1” in Zone “CC4”. Once the user has parked their vehicle 12 in the parking space 14, the user then opens the application on the mobile device 30 and enters the details of the parking matter as illustrated in FIG. 7 of the drawings. In particular, the user enters the parking identifier for the parking space 14 (“bb1”) and also the license plate number for their vehicle 12 as further shown in FIG. 7 of the drawings. It can be appreciated that the license plate does not have to be entered particularly if sensors are used in the parking spaces 14. The parking identifier for the parking space 14 and/or parking zone 13 may be painted in the parking location, displayed on a sign in the parking location, provided to the user via a printed ticket by a parking lot attendant or displayed on a map at the parking area. The user confirms that the parking space 14 identified on a map is correct as shown in FIG. 8 and then proceeds through the payment process for the parking space 14 as shown in FIGS. 9 through 10 of the drawings. Once the user has entered the proper payment information and credentials, the application then communicates with the server 20 to confirm payment for the parking space 14 resulting in a notice that payment has been accepted or declined as illustrated in FIG. 14 of the drawings.

Either after or before payment confirmation (FIG. 14), but after the user enters the parking identifier (FIG. 7), the server 20 determines if any promotional material 40 is available from businesses 18 for the parking location (parking space 14 or parking zone 13). Once the server 20 identifies one or more promotional materials 40 for the parking location, the server 20 then determines which promotional materials 40 are suitable for presentation to the user based upon the user's preferences. After one or more suitable promotional materials 40 have been identified, the server 20 then determines which of the suitable promotional materials 40 should have priority of display on the user's mobile device 30 based upon various factors such as the user's past shopping history (e.g. if the user has redeemed promotional codes 42 for a particular business in the past this business could have priority for its promotional material 40), the user's parking history (e.g. businesses 18 near where the user parks typically will be used), the amount of money being paid for each individual promotional material 40 (e.g. promotion material with higher advertising revenue may be given priority) and other consumer related factors. The promotional material 40 may be comprised of any type of advertisement, promotion, offer, special offer, sales event notice, entertainment event notice and the like for the businesses 18 near the parking location for the vehicle 12.

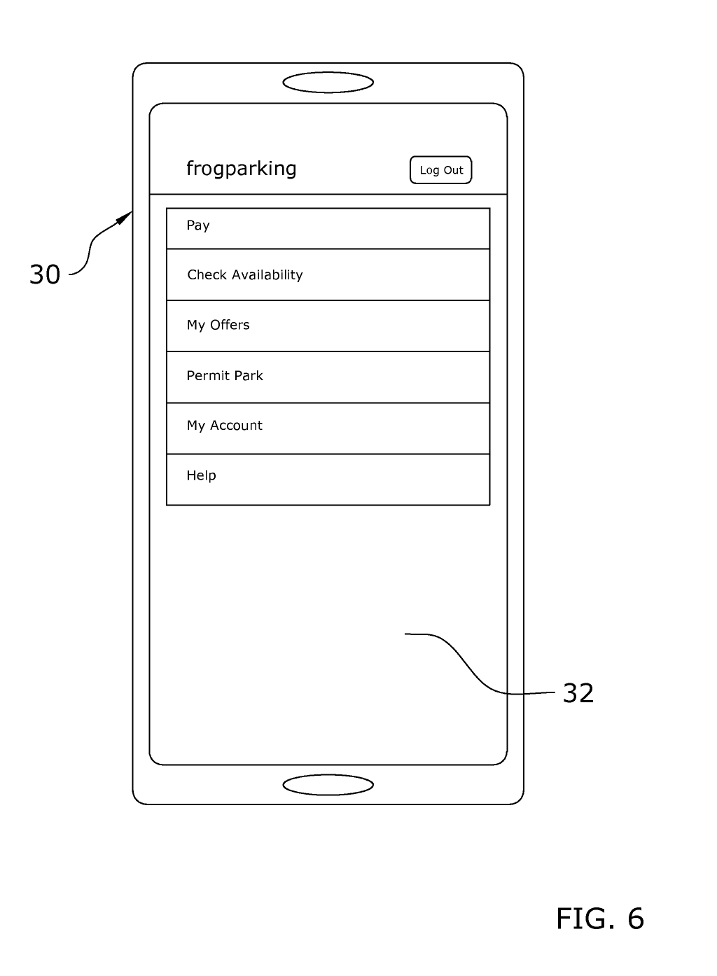

After one or more promotional materials 40 are selected by the server 20 to be provided to the user via the user's mobile device 30, the server 20 communicates the promotional material 40 to the mobile device 30 via the telecommunications network 16. The promotional material 40 may be saved upon the mobile device 30 for immediate or later display upon the display screen 32. The application on the mobile device 30 then selectively displays the promotional material 40 (one or more) upon the display screen 32 of the mobile device 30 for the user to view as illustrated in FIG. 12 of the drawings. The user may select via the display screen 32 or other input device (e.g. keyboard) of the mobile device 30 an option such as “Skip”, “Save”, “Share” or “Accept”. If the user selects Skip, the promotional material 40 is removed from the display screen 32 and the user is able to continue normal usage of the mobile device 30. If the user selects Save, then the application will save the promotional material 40 on the mobile device 30 for later retrieval by the user by selecting “My Offers” in the main menu shown in FIG. 6 of the drawings. If the user selects Share, then various options may be shown to the user allowing the user to share the promotional material 40 to friends and family via a social networking website such as FACEBOOK.

If the user selects “Accept” from the promotional material 40 displayed, the user is displayed a unique promotional code 42 from the server 20 that is associated with the user's account and the business as illustrated in FIG. 13 of the drawings. Alternatively, the promotion code may not be visibly displayed to the user and instead is communicated directly to the business at the time of redemption via electronic communication (e.g. wireless communication, wired communication). The promotional code 42 may be comprised of random characters, non-random characters such as words, a bar code or a QR code to be used by the user at the business to accept the promotional offer associated with the promotional material 40 (e.g. a specified percentage discount off a purchase, a free item with the purchase of another item). The user travels (e.g. wall(s) to the business (or drives through a drive-through of the business) within the redemption period and provides the promotional code 42 to the business to redeem the promotional offer from the business. For example, the promotional code 42 provided in FIG. 13 is “912HGS” which the user would then provide to the business. The business communicates the promotional code 42 to the server 20 for verification either via a computer or other electronic device. The communication of the promotional code 42 by the business to the server 20 may be done through the payment system of the business or manually via the staff of the business entering the code into a web interface of the server 20 using a computer (e.g. desktop computer, mobile device). The server 20 verifies if the promotional code 42 provided by the user is valid or not. If the promotional code 42 is not valid (e.g. expired, used too many times), the server 20 notifies the business that the promotional code 42 is no longer valid. If the promotional code 42 provided by the user to the business is valid, the server 20 notifies the business so the purchase transaction may be finalized between the business and the user subject to the benefits of the promotional offer (e.g. purchasing clothing at a 30% discount of the entire purchase price). This process may be repeated numerous times by the user and other users within the parking space 14.

For example, after the user drives their vehicle 12 into the parking zone 13 (Zone CC4) and parks the vehicle 12 in the parking space 14 (Space bb1), they will log into the application on their mobile device 30 and select the “Pay” option shown in FIG. 6 of the drawings. An interface is then displayed to the user where the user can enter the parking identifier for the parking space 14 and/or parking zone 13 as shown in FIG. 7. After the user enters the parking space 14 (Space bb1) into the interface of the application, the parking location data (e.g. GPS/positional information of the mobile device), including the parking identifier, vehicle 12 identification and user information (e.g. account number, name) are communicated to the server 20 for verification. The coordinates of the parking space 14 may be stored within the server 20 from satellite data or GPS measurements with the coordinate data entered and stored within the server 20. The server 20 searches a parking database that includes all of the parking spaces 14 and parking zones 13 monitored by the server 20. Once the server 20 verifies that the parking space 14 (based upon the parking identifier entered) is within the parking database, the server 20 then submits to the user verification of the parking location on a map to ensure that user has entered the correct parking identifier as illustrated in FIG. 8. Once the user verifies that the correct parking location is shown, the user is then taken to a payment page as shown in FIGS. 9 and 10 of the drawings. Once the payment information is submitted, either the payment confirmation page (FIG. 14) or a selected promotional material 40 (FIG. 12) is displayed to the user on the mobile device 30. As shown in FIG. 2, the mobile device 30 would display promotional material 40 from both Business 1 which advertises to all of the parking spaces 14 of Zone CC4 and Business 8 which advertises to parking spaces 14 adjacent to Business 1 (Spaces bb1, bb2, bb3 and bb4). The server 20 may provide one or more promotion materials to the mobile device 30 to be displayed depending upon user preferences and business account settings. When the promotional material 40 is displayed, the user may select any of the options as discussed previously. If the user selects “Accept”, the promotional code 42 is provided to the user to redeem at the business as shown in FIG. 13. The user goes to the business and provides the promotional code 42 to redeem the special offer from the business. As discussed previously, the business verifies the promotional code 42 by submitting the promotional code 42 to the server 20 which verifies if the promotional code 42 is still valid and confirms the same with the business. This process continues for various other users that park in the parking zone 13 (Zone CC4) or other parking zones 13.

Instead of or in combination with using the parking identifier entered by the user to determine the parking space 14 where the user is parking, the GPS coordinates from the mobile device 30 may be provided to the server 20 which may be matched with a parking space 14 within the server 20. However, GPS coordinates can be inaccurate and may result in an incorrect parking space 14 being identified. However, utilizing the combination of the parking identifier and the GPS coordinates may be useful to ensure the user has entered a valid parking identifier. Finally, the parking location may be determined by the proximity of the mobile device 30 being detected by a receiver such as a low-energy short-wavelength radio transmission (e.g. BLUETOOTH) wherein the receiver communicates with the server 20 the location of the mobile device 30.

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All publications, patent applications, patents, and other references mentioned herein are incorporated by reference in their entirety to the extent allowed by applicable law and regulations.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the invention will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the present invention, suitable methods and materials are described above. Thus, the present invention is not intended to be limited to the embodiments shown, but is to be accorded the widest scope consistent with the principles and features disclosed herein.

The invention claimed is:

1. A method for providing promotional material to a mobile device, comprising:
receiving promotional material information corresponding to one or more parking locations by a server;
entering a first parking identifier into a mobile device by a user, wherein said first parking identifier is associated with a location where said user parked a vehicle;
communicating said first parking identifier from said mobile device to said server via a telecommunications network;
identifying a first parking location corresponding to said parking identifier by said server;
identifying a first promotional material corresponding to said first parking location;
communicating said first promotional material to said mobile device by said server; and
providing said first promotional material to said user by said mobile device.

2. The method of claim 1, wherein said parking locations are comprised of parking spaces.

3. The method of claim 1, wherein said parking locations are comprised of one or more parking zones.

4. The method of claim 3, wherein said one or more parking zones are comprised of a parking lot.

5. The method of claim 1, wherein said step of providing said first promotional material includes displaying said first promotional material on a display screen of said mobile device.

6. The method of claim 5, including the step of said user selecting said first promotional material to accept a first promotional offer associated with said first promotional material.

7. The method of claim 6, including the step of displaying on said display screen a first promotional code associated with said first promotional offer and a first business.

8. The method of claim 7, including the step of providing said first promotional code to said business by said user.

9. The method of claim 8, including the step of communicating said first promotional code to said server by said business and further including the step of verifying said first promotional code by said server.

10. The method of claim 1, wherein said step of identifying a first promotional material includes utilizing user preferences of said user.

11. The method of claim 10, wherein said user preferences include types of promotional material said user does not want to receive.

12. The method of claim 1, including the step of sharing said first promotional material via a social network site.

13. A method for providing promotional material to a mobile device, comprising:
receiving user account information corresponding to a user by a server;
receiving promotional material information corresponding to a first business and to one or more parking locations by said server;
entering a first parking identifier into a mobile device by said user, wherein said first parking identifier is associated with a parking space;
communicating said first parking identifier from said mobile device to said server via a telecommunications network;
identifying said parking space corresponding to said parking identifier by said server;
identifying a first promotional material corresponding to said parking space;
communicating said first promotional material to said mobile device by said server; and
providing said first promotional material to said user by said mobile device.

14. The method of claim 13, wherein said step of providing said first promotional material includes displaying said first promotional material on a display screen of said mobile device.

15. The method of claim 14, including the step of said user selecting said first promotional material to accept a first promotional offer associated with said first promotional material.

16. The method of claim 15, including the step of displaying on said display screen a first promotional code associated with said first promotional offer and a first business.

17. The method of claim 16, including the step of providing said first promotional code to said business by said user.

18. The method of claim 17, including the step of communicating said first promotional code to said server by said business and further including the step of verifying said first promotional code by said server.

19. A method for providing promotional material to a mobile device, comprising:
receiving user account information corresponding to a user by a server;
receiving promotional material information corresponding to a first business and to one or more parking locations by said server, wherein said one or more parking locations are comprised of a plurality of parking spaces within a parking zone;
entering a first parking identifier into a mobile device by said user, wherein said first parking identifier is associated with a selected parking space and said parking zone which said selected parking space is located;
communicating said first parking identifier from said mobile device to said server via a telecommunications network;
identifying said selected parking space corresponding to said parking identifier by said server;
identifying a first promotional material corresponding to said selected parking space or said parking zone;
communicating said first promotional material to said mobile device by said server; and
displaying said first promotional material on said mobile device.

20. The method of claim 1, wherein said step of identifying a first promotional material includes utilizing user preferences of said user, wherein said user preferences include types of promotional material said user does not want to receive.
